(19) United States
(12) Patent Application Publication
(10) Pub. No.: US 2024/0054615 A1
(43) Pub. Date: Feb. 15, 2024

(54) Denoising of Raw Camera Images Using AI-based Image Denoising

(71) Applicant: Meta Platforms, Inc., Menlo Park, CA (US)

(72) Inventors: Lucas Young, Hayward, CA (US); Zhuo Hui, Bellevue, WA (US); Denis Demandolx, Bellevue, WA (US); Rakesh Ranjan, Sunnyvale, CA (US); Yuchen Fan, San Jose, CA (US)

(21) Appl. No.: 17/887,157

(22) Filed: Aug. 12, 2022

(51) Int. Cl. G06T 5/00; G06T 3/00; G06T 5/50; G06T 7/38; G06T 7/00

(52) U.S. Cl. CPC G06T 5/002; G06T 3/0093; G06T 5/50; G06T 7/38; G06T 7/0002; G06T 2207/10024; G06T 2207/30168; G06T 2207/20081; G06T 2207/20084

(57) ABSTRACT

In one embodiment, a method includes accessing a sequence of raw images comprising at least a first raw image, a second raw image, and a third raw image sequentially, wherein the second raw image comprises image noise, warping the first and third raw images with respect to the second raw image based on an optical flow associated with the sequence of raw images, generating an input tensor based on the first warped raw image, the second raw image, and the third warped raw image, and generating a denoised raw image based on one or more machine-learning models for the second raw image based on the input tensor.

### TECHNICAL FIELD

This disclosure generally relates to image denoising, and in particular relates to deep learning for image denoising.

### BACKGROUND

One of the fundamental challenges in the field of image processing and computer vision is image denoising, where the underlying goal is to estimate the original image by suppressing noise from a noise-contaminated version of the image. Image noise may be caused by different intrinsic (i.e., sensor) and extrinsic (i.e., environment) conditions which are often not possible to avoid in practical situations. Therefore, image denoising plays an important role in a wide range of applications such as image restoration, visual tracking, image registration, image segmentation, and image classification, where obtaining the original image content is crucial for strong performance. While many algorithms have been proposed for the purpose of image denoising, the problem of image noise suppression remains an open challenge, especially in situations where the images are acquired under poor conditions where the noise level is very high.

Deep learning (also known as deep structured learning) is part of a broader family of machine-learning methods based on artificial neural networks with representation learning. Learning can be supervised, semi-supervised or unsupervised. Deep-learning architectures such as deep neural networks, deep belief networks, deep reinforcement learning, recurrent neural networks and convolutional neural networks have been applied to fields including computer vision, speech recognition, natural language processing, machine translation, bioinformatics, drug design, medical image analysis, climate science, material inspection and board game programs, where they have produced results comparable to and in some cases surpassing human expert performance. The adjective “deep” in deep learning refers to the use of multiple layers in the network. Early work showed that a linear perceptron cannot be a universal classifier, but that a network with a nonpolynomial activation function with one hidden layer of unbounded width can. Deep learning is a modern variation which is concerned with an unbounded number of layers of bounded size, which permits practical application and optimized implementation, while retaining theoretical universality under mild conditions.

### SUMMARY OF PARTICULAR EMBODIMENTS

In particular embodiments, a computing system may denoise an image captured by a camera. In one embodiment, the computing system may use other images captured by the camera from different viewpoints and at different times (e.g., images captured using burst mode) to assist denoising of a target image. As an example and not by way of limitation, in a sequence of three captured images, the middle image may be the target image and may be denoised using information from the other two images. The other two images may be first warped using optical flow so that they represent the scene when the target image was captured. The two warped images, along with the target image, may be then processed by a machine-learning model trained for image denoising to denoise the target image. In another embodiment, the computing system may reduce border artifacts when denoising is performed tile by tile for an image that was divided into many tiles. Specifically, a split luminance-chrominance architecture for denoising may be used. Although this disclosure describes particular image denoising in particular manners, this disclosure contemplates any suitable image denoising in any suitable manner.

In particular embodiments, the computing system may access a sequence of raw images comprising at least a first raw image, a second raw image, and a third raw image sequentially. The second raw image may comprise image noise. In particular embodiments, the computing system may then warp the first and third raw images with respect to the second raw image based on an optical flow associated with the sequence of raw images. The computing system may then generate an input tensor based on the first warped raw image, the second raw image, and the third warped raw image. In particular embodiments, the computing system may further generate, based on one or more machine-learning models, a denoised raw image for the second raw image based on the input tensor.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example pair of a clean raw image and its corresponding noisy image.

FIG. 2 illustrates an example correlation between per-pixel variance and intensity.

FIG. 3 illustrates an example flow diagram for burst denoising.

FIGS. 4A-4B illustrate example image denoising based on the embodiments disclosed herein.

FIG. 5 illustrates an example correlation between the computation and tile overlap size measured in GMACs.

FIG. 6 illustrates example unsightly sharp color transitions between tiles.

FIG. 7 illustrates an example split luma-chroma architecture.

FIG. 8 illustrates example preservation of smooth color transitions between tiles.

FIG. 9A illustrates an example comparison between a baseline output and output from our model.

FIG. 9B illustrates another example comparison between a baseline output and output from our model.

FIG. 10 illustrates an example method for image denoising.

FIG. 11 illustrates an example computer system.

### DESCRIPTION OF EXAMPLE EMBODIMENTS

In particular embodiments, a computing system may denoise an image captured by a camera. In one embodiment, the computing system may use other images captured by the camera from different viewpoints and at different times (e.g., images captured using burst mode) to assist denoising of a target image. As an example and not by way of limitation, in a sequence of three captured images, the middle image may be the target image and may be denoised using information from the other two images. The other two images may be first warped using optical flow so that they represent the scene when the target image was captured. The two warped images, along with the target image, may be then processed by a machine-learning model trained for image denoising to denoise the target image. In another embodiment, the computing system may reduce border artifacts when denoising is performed tile by tile for an image that was divided into many tiles. Specifically, a split luminance-chrominance architecture for denoising may be used. Although this disclosure describes particular image denoising in particular manners, this disclosure contemplates any suitable image denoising in any suitable manner.

In particular embodiments, the computing system may access a sequence of raw images comprising at least a first raw image, a second raw image, and a third raw image sequentially. The second raw image may comprise image noise. In particular embodiments, the computing system may then warp the first and third raw images with respect to the second raw image based on an optical flow associated with the sequence of raw images. The computing system may then generate an input tensor based on the first warped raw image, the second raw image, and the third warped raw image. In particular embodiments, the computing system may further generate, based on one or more machine-learning models, a denoised raw image for the second raw image based on the input tensor.

Images may have noise, especially in low-light conditions. Noise may be removed via signal processing methods, but the texture underneath a noisy pixel would be missing during denoising. In particular embodiments, deep learning algorithms, e.g., based on convolutional neural networks, may not only remove the noise but also fill in missing textures that were originally obscured by noise. Based on the data driven approach, deep learning algorithms may be able to look at the spatial correlations and look at the image and be able to determine in a different way what is the underlying texture that was obscured by the noise.

Raw image denoising is the task of removing/reducing noise artifacts in real-world raw camera images. Using raw images for denoising may be advantageous because noise may be more well behaved given it is spatially independent. If the raw image is converted to a normal three-channel (RGB) image, the digital signal processing process (e.g., de-mosaic process) may introduce undesired dependencies between pixels. Another advantage may be that the raw image may have more bits/information without quantization. It may be also easier to model the noise based on the raw image.

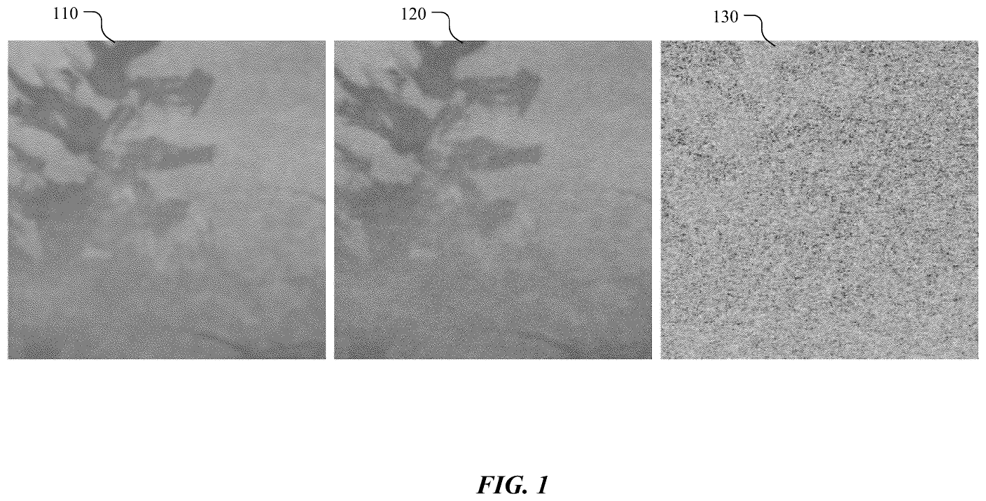

Image noise in the raw domain may follow a gaussian distribution. The image noise introduced from various sources may add variance to the true intensity of the image. These sources may add variance that is either linearly correlated with intensity (signal dependent noise) or constant (signal independent noise). To calibrate, a set of clean and noisy pairs may be taken by manipulating ISO and exposure time. The per-pixel error may be obtained by the difference between pairs. FIG. 1 illustrates an example pair of a clean raw image and its corresponding noisy image. Image 110 is a clean raw image and image 120 is its corresponding noisy raw image. Image 130 indicates the per-pixel error.

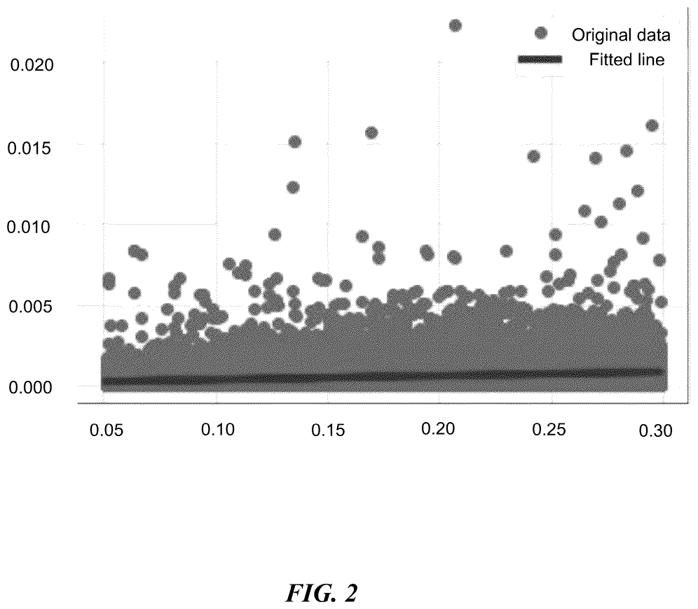

FIG. 2 illustrates an example correlation between per-pixel variance and intensity. For each image pair, the per-pixel variance is plotted versus intensity. Thus, the slope of the linear regression may represent the signal-dependent noise and the intercept may represent the signal-independent noise. The amount of signal-dependent noise and signal-independent noise may depend on the ISO or gain of the exposure. This may be modeled via linear regression. In training, we may randomly sample a gain and derive signal-dependent and signal-independent noise parameters to inject noise representative of the target sensor. Quantization of the signal may be also modeled to simulate low-light conditions. In inference, we may derive the signal-dependent and signal-independent noise parameters based on the gain in the exposure's metadata. These parameters may be fed to the denoising model for additional context on the input data, yielding superior denoising accuracy.

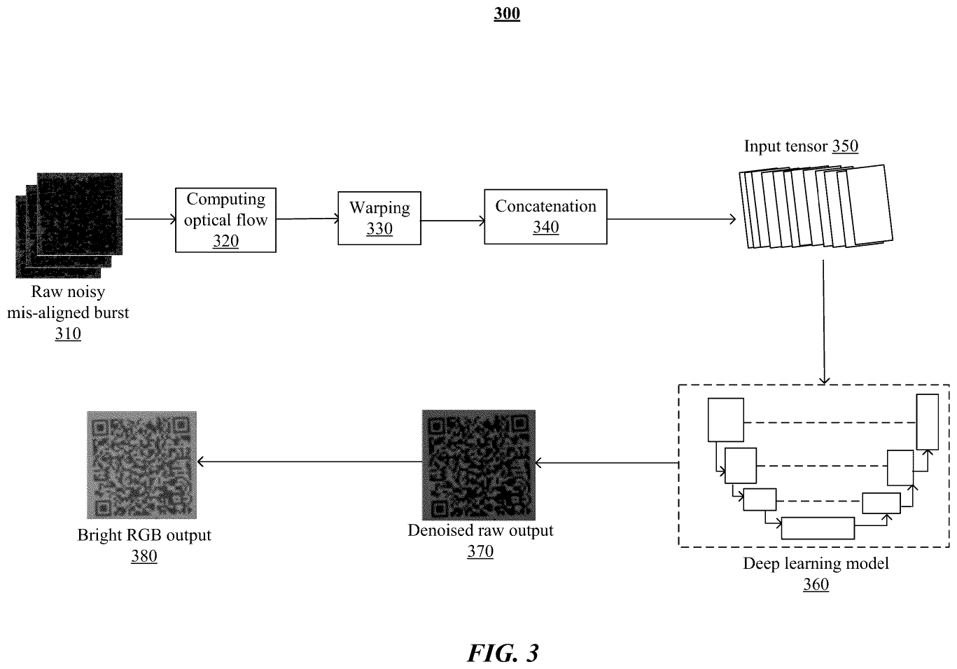

FIG. 3 illustrates an example flow diagram 300 for burst denoising. In particular embodiments, the computing system may utilize burst denoising for denoising a raw image. Burst image denoising may utilize information from a burst/sequence of raw images to produce a single denoised image. A burst of raw images may comprise a set of raw images collected together in a rapid sequence. To begin with, a camera may capture a sequence of raw images. The sequence of raw images may be associated with slightly different viewpoints. The sequence of raw images may be misaligned. As an example and not by way of limitation, the sequence of raw images may comprise three raw images. For simplicity throughout this disclosure, the embodiments would be described according to three raw images in a sequence. However, this disclosure contemplates that the embodiments disclosed herein may be applicable to any suitable number that is more than three. The raw noisy misaligned burst of images 310 may be needed to help fill in the holes of the noise for the targe raw image in the middle. Each raw image may comprise minimally processed data from the image sensor of the camera. Each of the sequence of raw images may be based on RGGB channels instead of RGB channels. Each raw image may have a single channel for the sensor patterns (e.g., Bayer pattern).

In particular embodiments, the computing system may generate the optical flow 320 associated with the sequence of raw images. The computing system may first convert the first raw image, the second raw image, and the third raw image to a first black-and-white raw image, a second black-and-white raw image, and a third black-and-white raw image, respectively. In particular embodiments, each of the first, second, and third raw images may be associated with a first resolution. Each of the first, second, and third black-and-white raw images may be associated with a second resolution. In particular embodiments, the second resolution may be lower than the first resolution. The computing system may then generate an initial optical flow based on the first, second, and third black-and-white raw images. The initial optical flow may be associated with the second resolution. The computing system may further generate the optical flow by increasing a resolution of the initial optical flow from the second resolution to the first resolution.

The following describes an example process for generating the optical flow. For each raw image, the computing system may combine the pixel values for each set of 2×2 RGGB values into one pixel value to generate a corresponding black-and-white image. As an example and not by way of limitation, the computing system may use average pooling to generate the black-and-white images from their respective raw images. The height and width of the resulting black-and-white image may be half of the original raw image. As an example and not by way of limitation, if the raw image is 64×64, the black-and-white image may be 32×32. In particular embodiments, the alignment may occur in the black-and-white, 1-channel space. The computing system may then use the black-and-white images to generate optical flow between the first image and the second image, and between the third image and the second image. However, the resolution of such optical flow may be not as high as the raw images. Continuing with the previous example of the 64×64 raw image, the optical flow may be 32×32. As a result, the computing system may need to increase the resolution of the optical flow back to the full resolution of the raw image, e.g., 64×64.

After full-resolution optical flow is obtained, the computing system may perform warping 330 based on the optical flow of the black-and-white images. In particular embodiments, the corresponding first raw image and third raw image may be warped to alignment with the second raw image. The computing system may warp the first raw image to the second raw image and warp the third raw image to the second raw image. In particular embodiments, the halved spatial dimensions of the black-and-white images, e.g., 32×32 as in the aforementioned example, may be taken into account during warping. To this end, we may have three aligned images comprising the original second raw image and the two warped raw images generated from the first and second raw images.

In particular embodiments, the computing system may separate each of the first warped raw image, the second raw image, and the third warped raw image to a first number of channels. As an example and not by way of limitation, the computing system may separate each of these three aligned images into four color channels, i.e., RGGB. Each resulted image may have half of the original dimension. Continuing with the previous example of the 64×64 raw image, each resulted image based on RGGB channels may be 32×32 instead of 64×64.

In particular embodiments, generating the input tensor may comprise combining the first warped raw image, the second raw image, and the third warped raw image based on the first number of channels associated with each of the first warped raw image, the second raw image, and the third warped raw image. The input tensor may be associated with a second number of channels, which may be greater than the first number. At the step 340 of concatenation, the computing system may stack the three aligned images based on RGGB channels together to form a 12-channel input tensor 350. The input tensor 350 may be aligned. The tensor 350 may be fed to a deep learning model 360. As an example and not by way of limitation, the deep learning model 360 may comprise a convolutional neural network.

In particular embodiments, the computing system may generate, based on the input tensor by the one or more machine-learning models, an intermediate raw image. The intermediate raw image may be associated with the first number of channels. The computing system may further reassemble the first number of channels associated with the intermediate raw image to generate the denoise raw image. As illustrated in FIG. 3, the deep learning model 360 may infer the denoised raw output 370 (intermediate raw image), which may be a 4-channel output image. The denoised, 4-channel output image 370 may be a noise-free raw output.

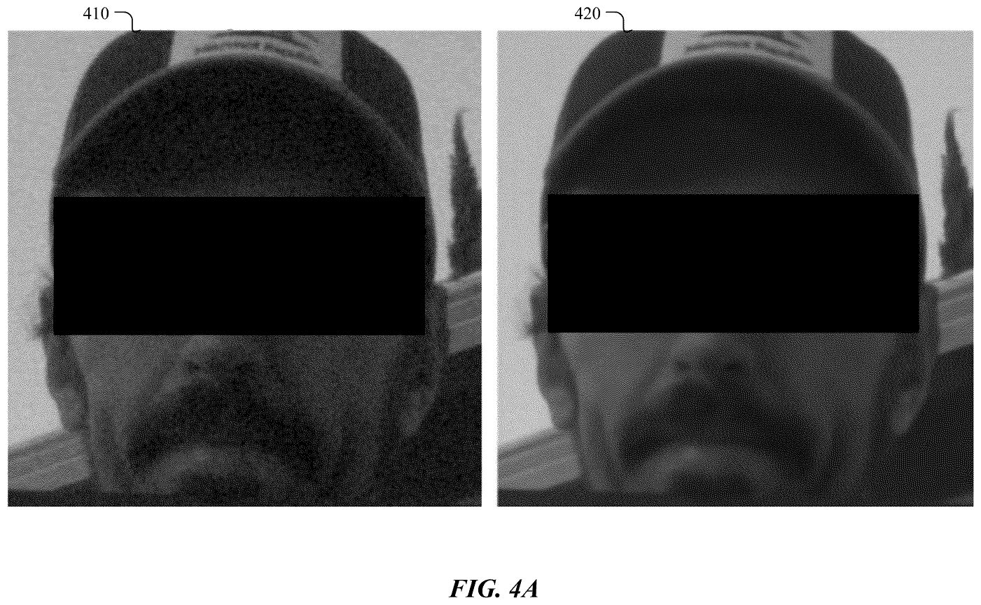

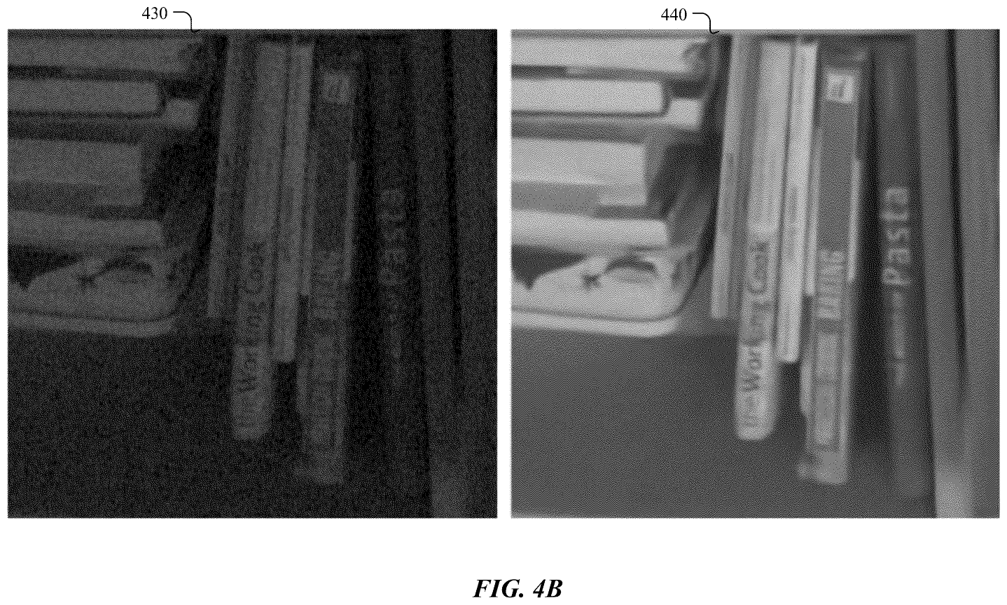

In particular embodiments, the computing system may generate, based on one or more image signal processors, a denoised RGB or YUV image from the denoised raw image. As illustrated in FIG. 3, the computing system may further generate digital gain using an image signal processor (ISP) on the noise-free raw output to attain a bright RGB output 380. FIGS. 4A-4B illustrate example image denoising based on the embodiments disclosed herein. In FIG. 4A, the denoised image 420 is of noticeably better quality than the input image 410. In FIG. 4B, the denoised image 440 is of noticeably better quality than the input image 430.

In particular embodiments, the deep learning model may be trained with supervised learning for denoising. The deep leaning model may be pre-trained on noise-free training images, which may be also considered ground-ruth images. In particular embodiments, a photon-curve based method may be used to parameterize an artificial noise addition function representative of our denoising solution's target sensor. The computing system may then synthesize training pairs by duplicating each ground truth image such that there are three images, and adding artificial noise to the three images to generate three real noisy raw bursts. Synthesizing training pairs may be advantageous in that we may generate an infinite number of pairs for each clean image since we may generate one noisy image but also as many noisy images as we want based on the photon-curve based method. In particular embodiments, the computing system may separate each of these real noisy raw bursts into four color channels, i.e., RGGB. The computing system may then stack the real noisy raw bursts based on RGGB channels together to form a 12-channel tensor. Since there is no misalignment, the optical flow and warping step may be skipped.

The deep learning model may be then fine-tuned based on the real noisy raw bursts and their paired ground-truth images. During fine-tuning, the deep learning model, e.g., based on U-Net, may process the 12-channel input tensor corresponding to the real noisy raw bursts and generate a 4-channel output image. In particular embodiments, the computing system may recreate a raw image based on the 4-channel image because the raw image may have not been de-mosaiced or processed by the digital signal processor. To do so, the four channels may be reassembled to form a denoised raw image. The dimension of this denoised raw image may be the same as the original raw images, e.g., 64×64. The denoised raw image may be then processed by an image signal processor (ISP) to generate an output RGB image. In particular embodiments, the computing system may compare the denoised RGB or YUV image with a ground-truth clean image and update the one or more machine-learning models based on the comparison. As an example and not by way of limitation, the computing system may compute a training loss as the L1 difference between this output RGB image and the original single ground-truth image, with the loss back-propagated to update the deep learning model.

In particular embodiments, the deep learning model may need to be deployed onto computing devices with limited computing resources such as AR wearables. One technical challenge for this may be producing a high-quality denoised image with the limited compute and battery power of these devices. Besides slow runtime, the accelerator of a deep convolutional neural network (CNN) may also have very limited SRAM. The networks' maximum memory activation may need to fit within SRAM to avoid spilling into DRAM, which may greatly increase runtime and power consumed, e.g., by tiling the input image into 256×256-sized tiles, the maximum memory activation of the network may be limited to that of the tile rather than the full image.

To deploy a deep learning model onto a resource-constrained device, the deep learning model may need to operate on smaller sub-tiles of the original full-resolution image. This may limit the maximum memory consumed by the deep learning model at a single point in time, as the deep learning model may only operate on a small region at a time. To reduce the maximum memory activation of the deep learning model, we may split input images into smaller tiles. The reduced memory activation may enable the deep learning model to solely leverage SRAM rather than spill into DRAM. Accessing 1 byte in DRAM may consume about 80 pJ, while accessing the same byte in SRAM may only consume about 10 pJ. Hence, preventing DRAM spills may drastically reduce the power consumption of the deep learning model. In particular embodiments, the deep learning model may utilize many sliding kernel operations, meaning that a given pixel in the output image may depend on many surrounding input pixels. This surrounding region may be termed the receptive field of an output pixel.

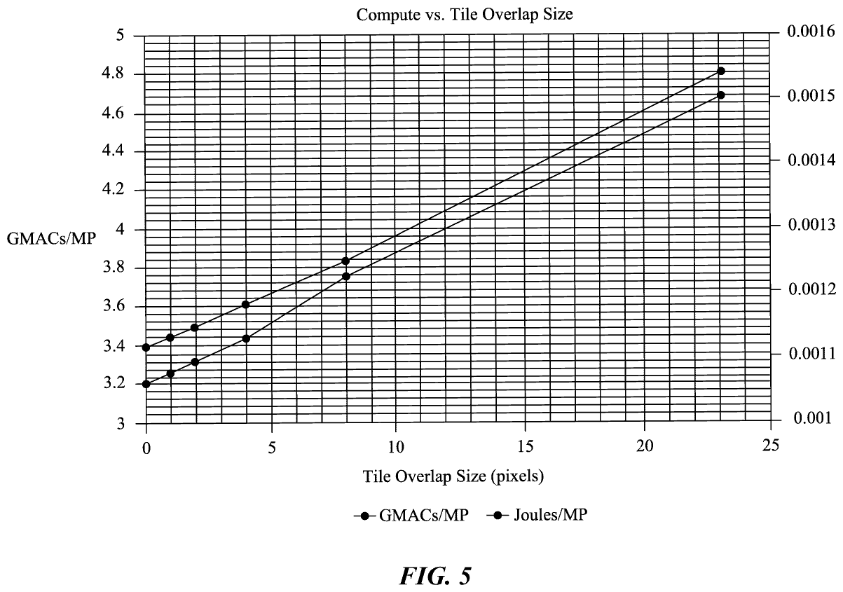

Due to tiling, output pixels on the borders of output tiles may not have access to one side of its surrounding receptive field, curtailing the fidelity of the predicted output pixel. In other words, tiling input images with a small tile overlap size may reduce the available receptive field to the deep learning model, which may introduce unsightly artifacts along tiling borders. A trivial solution to this may be to have the input tiles overlap enough to guarantee that every output pixel receives its full receptive field. As an example and not by way of limitation, some padding/overlapping region may be included in each tile. For example, if the desired tile is 100×100 pixels, we may pad the surrounding pixels to make it 110×110 so that the image processing has enough information to properly handle the borders of the 100×100 tile. Particularly, convolutional neural networks may have large receptive fields, which can benefit from the surrounding region. However, increasing the tile padding may increase inefficiency as each overlapping pixel may need to be run through the model twice for both tiles, which may be wasted computation. As a result, we may want to minimize the overlapping required, which may cause tiling artifact in image denoising. FIG. 5 illustrates an example correlation between the computation and tile overlap size measured in GMACs. FIG. 5 demonstrates the effect that the amount of overlapping pixels has on the number of MACs it takes to process a full tiled image. For context, an efficient denoising U-Net may require an overlap of 23 pixels for its tiled output to be computationally equivalent to its non-tiled output. Achieving computational equivalence to running the model without tiling may require a 41% increase in GMACs/MP. It may be not computationally efficient to have large overlap between tiles. However, with limited overlap between tiles, the deep learning model may generate unsightly artifacts along tile borders due to the limited context near the edge of the input tile.

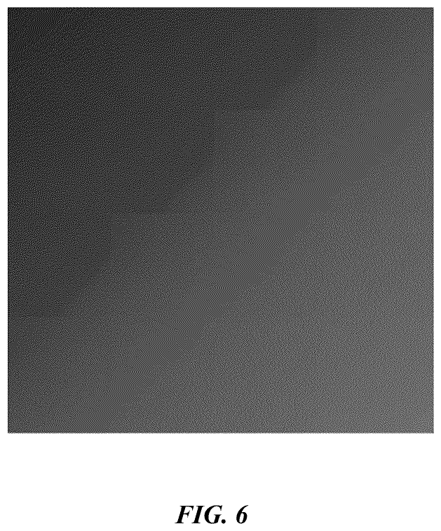

In image denoising, severe chroma noise may distort the color throughout the input image to the deep learning model. The deep learning model may be tasked with recovering the original color of a given region of the input image as if it were noise-free. This task may be problematic in tiling, because along a gradient-like texture, the model may not have context on how the color transitions into surrounding tiles. Thus, with limited tile overlap size, sharp transitions in color may be observed between tiles. FIG. 6 illustrates example unsightly sharp color transitions between tiles. When tiled denoising is performed on a gradient texture, the deep learning model may not preserve smooth color transitions between tiles because the model may not have access to the colors in the adjacent tiles.

In dealing with the color-transition problem, there may be two considerations. One consideration may be the technical challenge of the recovery of fine, high-frequency detail that is obscured by the input-degradation (either noise or low-resolution). It is well-known that the high-frequency details are nearly solely encapsulated by the luminance of the image, the green channels (GG). Another consideration may be that the cost of increasing tile overlap is proportional to the model size rather than a fixed amount of compute. That is, for an extremely small model, the cost of increasing the tile overlap size may be negligible. Based on these considerations, we may utilize a network architecture that separates the deep learning model into a luminance branch and a lightweight chrominance branch to resolve the tiling artifact while preserving the limited tile overlap size. In particular embodiments, the luminance branch may operate solely on the luminance (GG channels), while the chrominance branch may be solely responsible for predicting the chrominance (R and B channels) of the output image.

In particular embodiments, luminance denoising may be more difficult because it may comprise high-frequency noisy information, whereas chrominance denoising may be simpler because it may comprise lower-frequency noisy information. However, luminance may have less spatial dependency so it may not require a large overlapping region, for which a larger network may be used. Chrominance may need more overlapping to ensure smooth color transitions, but since the problem may be solved by a small network, we may afford to give chrominance a larger overlapping region without significantly impacting performance. In particular embodiments, tiles with different overlap sizes may be fed to each branch. Because the color-transition problem primarily lies with the chrominance aspect of denoising, we may feed the chrominance branch a large receptive field, e.g., 12 pixels of tile overlap. This may come at a negligible additional computational cost because increasing the tile overlap size for the small branch may be a proportional cost.

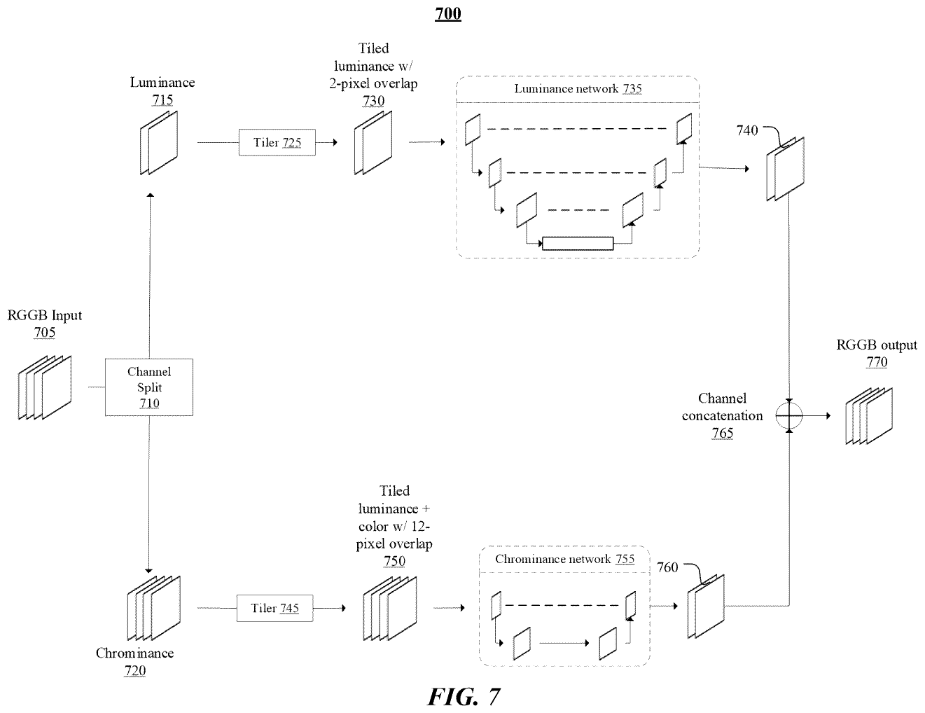

FIG. 7 illustrates an example split luma-chroma architecture 700. In particular embodiments, the model may first take a 4-channel (i.e., RGGB) input image 705. With channel split 710, the model may split the input image into luminance 715 and chrominance 720. In particular embodiments, the luminance image 715 may be based on a plurality of luminance channels. As illustrated in FIG. 7, luminance 715 may be captured by the G and G channels. In particular embodiments, the chrominance image 720 may be based on a plurality of chrominance channels (e.g., R and B channels). In alternative embodiments, the chrominance image 720 may be based on a plurality of first luminance-chrominance channels (e.g., RGGB channels). A number of the plurality of luminance channels may be smaller than a first number of the plurality of first luminance-chrominance channels. As illustrated in FIG. 7, chrominance 720 may be captured by the R and B channels but it may be helpful to also include the G and G channels.

For luminance 715, the luminance image based on GG channels may be then processed by a first tiler 725 to be split into tiles with a small 2-pixel padding overlap 730. In particular embodiments, the tiled luminance with 2-pixel overlap 730 may be then processed by a luminance network 735. As an example and not by way of limitation, the luminance network 735 may be based on a U-Net. The channel count of the luminance network 735 may be trivially reduced such that it may require 90% of the MACs of the baseline network of the deep learning model, making space in the compute budget for the separate chrominance branch. In particular embodiments, the luminance network 735 may process the tiled luminance with 2-pixel overlap 730 to generate the desired denoised tiles based on GG channels 740. The denoised tiles based on GG channels 740 may have no padding.

For chrominance 720, the 4-channel image (i.e., RGGB) may be split into tiles with much larger 12-pixel padding overlap 750 by a second tiler 745. In particular embodiments, the chrominance network 755 may be an extremely small network. As an example and not by way of limitation, the chrominance network 755 may be a small U-Net, only consisting of 4 convolutions, requiring only 10% of the MACs of the baseline network of the deep learning model. The unbalanced allocation of compute between luminance and chrominance may be appropriate, because as per observation 1, the primary challenge of neural denoising is allocated 90% of the compute budget. In particular embodiments, the chrominance network 755 may process the tiled luminance plus color with 12-pixel overlap 750 and output only the tiles based on RB channels 760. The outputted tiles based on GG channels 740 and the tiles based on RB channels 760 may be further combined based on channel concatenation 765 to form the RGGB output 770.

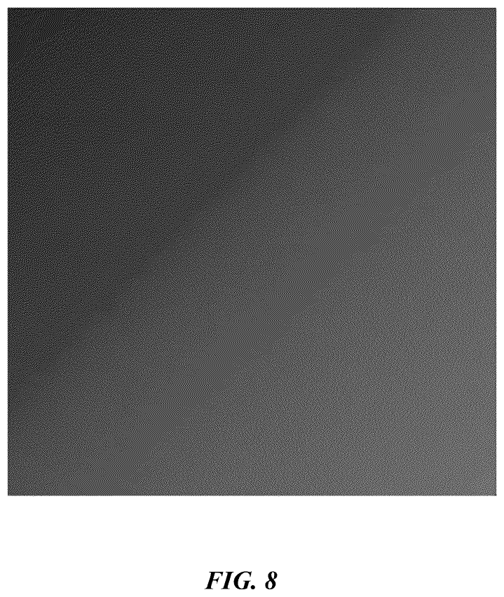

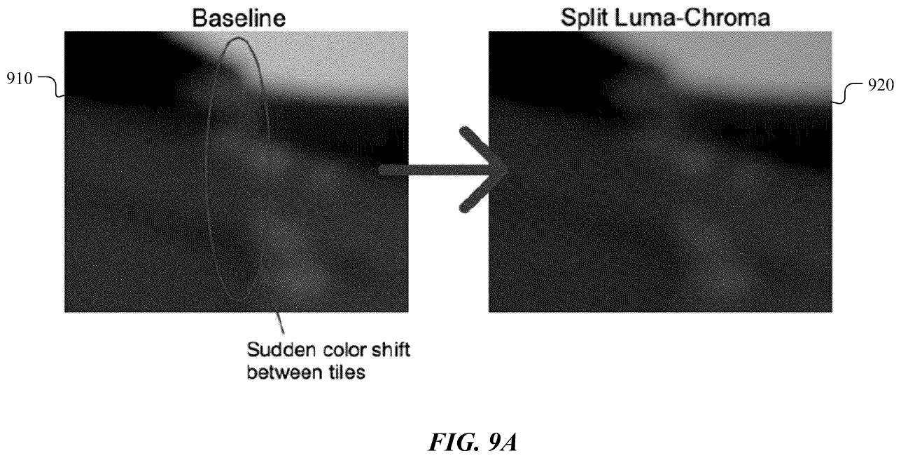

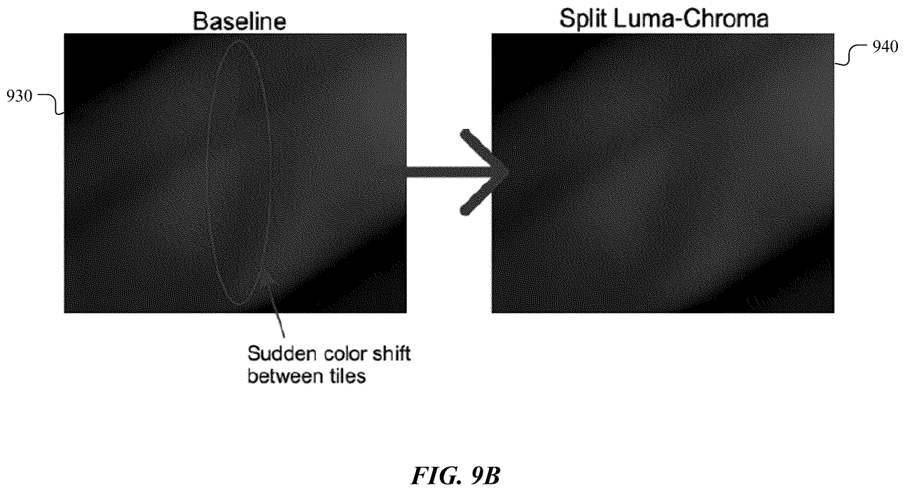

FIG. 8 illustrates example preservation of smooth color transitions between tiles. FIG. 8 shows the output of the deep learning model based on the split luma-chroma architecture. As may be seen, smooth color transitions between tiles are preserved. FIG. 9A illustrates an example comparison between a baseline output 910 and output from our model 920. The baseline output 910 was generated by a single U-Net with a tile overlap of 2 pixels, which creates a sharp contrast in the color between tiles. Our deep learning model based on the split luma-chroma architecture 700 may resolve this issue with the same compute. FIG. 9B illustrates another example comparison between a baseline output 930 and output from our model 940. The baseline output 930 was generated by a single U-Net with a tile overlap of 2 pixels, which creates a sharp contrast in the color between tiles. Our deep learning model based on the split luma-chroma architecture 700 may resolve this issue with the same compute.

In particular embodiments, the deep learning model based on the split luma-chroma architecture 700 may be trained based on training data. Suppose the training is based on a plurality of pairs of noise-free and noisy images. For each noisy image based on tiles, the deep learning model based on the split luma-chroma architecture 700 may process it to generate a denoised RGGB output. The denoised RGGB output may be then compared to the noise-free image using a loss function. In particular embodiments, the comparison may be based on either the entire noise-free image or the tiles of the noise-free image. The loss computed from the loss function may be backpropagated to update both the luminance network 735 and the chrominance network 755.

In particular embodiment, the computing system may apply the deep learning model based on the split luma-chroma architecture 700 to a burst of raw images for image denoising. Referring back to the flow diagram 300 in FIG. 3, after computing the optical flow 320, warping 330, and concatenation 340, we may have a 12-channel input tensor 350. As may be seen, the input tensor may be based on a plurality of luminance-chrominance channels. In particular embodiments, the computing system may then use the deep learning model based on the split luminance-chrominance architecture 700, instead of the deep learning model 360, to this 12-channel tensor 350. The channel split 710 may split the input tensor 350 to obtain the luminance 715 and chrominance 720. In particular embodiments, the luminance 715 may comprise all 6 luminance channels and the chrominance 720 may comprise all 12 channels. The luminance 715 may be provided to the luminance network 735, which may then predict two luminance channels. In particular embodiments, chrominance 720 may be provided to the chrominance network 755, which may predict two chrominance channels. The predicted luminance channels by the luminance network 735 and the predicted chrominance channels by the chrominance network 755 may be further combined to generate the RGGB output 765.

In particular embodiments, generating the denoised raw image for the second raw image based on the input tensor 350 may comprise the following steps. The computing system may process the input tensor based on the one or more machine-learning models to generate a luminance image and a chrominance image. As described above, in particular embodiments, the luminance image may be based on a plurality of luminance channels and the chrominance image may be based on a plurality of first luminance-chrominance channels. In this case, the input tensor may be based on a plurality of second luminance-chrominance channels. The first number of the plurality of the first luminance-chrominance channels may be smaller than a second number of the plurality of second luminance-chrominance channels. As described above, in alternative embodiments, the luminance image may be based on a plurality of luminance channels and the chrominance image may be based on a plurality of chrominance channels. In this case, the input tensor may be based on a plurality of luminance-chrominance channels. A first number of the plurality of luminance channels and a second number of the plurality of chrominance channels may be each smaller than a third number of the plurality of luminance-chrominance channels.

In particular embodiments, the computing system may then split the luminance image into a plurality of first tiles. Each of the plurality of first tiles may be based on a first padding overlap of a first number of pixels (e.g., 2 pixels). In particular embodiments, the computing system may split the chrominance image into a plurality of second tiles. Each of the plurality of second tiles may be based on a second padding overlap of a second number of pixels (e.g., 12 pixels). As can be seen, the first number may be smaller than the second number.

In particular embodiments, the computing system may then process the plurality of first tiles based on the one or more machine-learning models to generate a plurality of denoised first tiles. Each of the plurality of denoised first tiles may be based on the plurality of luminance channels. The computing system may process the plurality of first tiles based on the one or more machine-learning models to generate a plurality of denoise second tiles. Each of the plurality of denoised second tiles may be based on the plurality of chrominance channels. As illustrated in FIG. 7, the one or more machine-learning models may comprise a neural network comprising a luminance network 735 and a chrominance network 755. Accordingly, generating the plurality of denoised first tiles may be based on the luminance network 735 whereas generating the plurality of denoised second tiles may be based on the chrominance network 755. As described above, a first size of the luminance network 735 may be larger than a second size of the chrominance network 755. In particular embodiments, the computing system may further combine the plurality of denoise first tiles and the plurality of denoise second tiles to generate the denoised raw image for the second raw image.

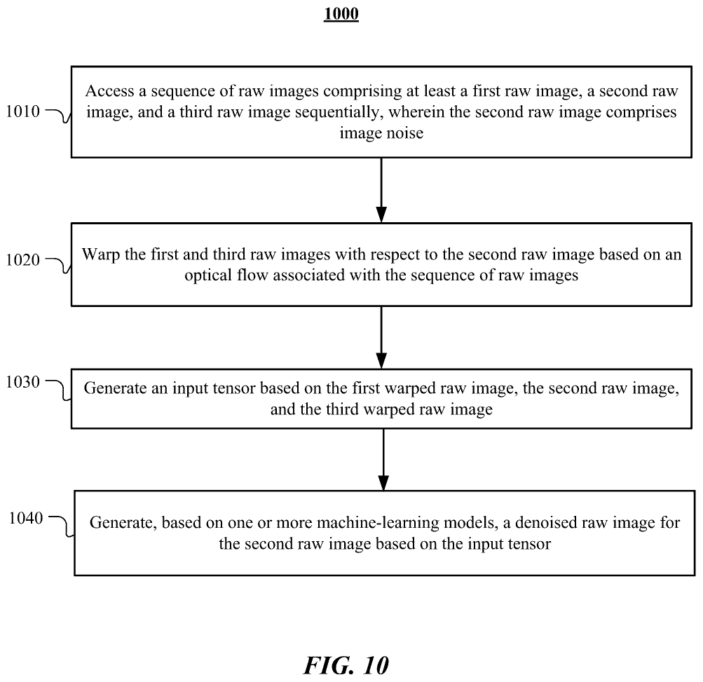

FIG. 10 illustrates an example method 1000 for image denoising. The method may begin at step 1010, where the computing system may access a sequence of raw images comprising at least a first raw image, a second raw image, and a third raw image sequentially, wherein the second raw image comprises image noise. At step 1020, the computing system may warp the first and third raw images with respect to the second raw image based on an optical flow associated with the sequence of raw images. At step 1030, the computing system may generate an input tensor based on the first warped raw image, the second raw image, and the third warped raw image. At step 1040, the computing system may generate, based on one or more machine-learning models, a denoised raw image for the second raw image based on the input tensor. Particular embodiments may repeat one or more steps of the method of FIG. 10, where appropriate. Although this disclosure describes and illustrates particular steps of the method of FIG. 10 as occurring in a particular order, this disclosure contemplates any suitable steps of the method of FIG. 10 occurring in any suitable order. Moreover, although this disclosure describes and illustrates an example method for image denoising including the particular steps of the method of FIG. 10, this disclosure contemplates any suitable method for image denoising including any suitable steps, which may include all, some, or none of the steps of the method of FIG. 10, where appropriate. Furthermore, although this disclosure describes and illustrates particular components, devices, or systems carrying out particular steps of the method of FIG. 10, this disclosure contemplates any suitable combination of any suitable components, devices, or systems carrying out any suitable steps of the method of FIG. 10.

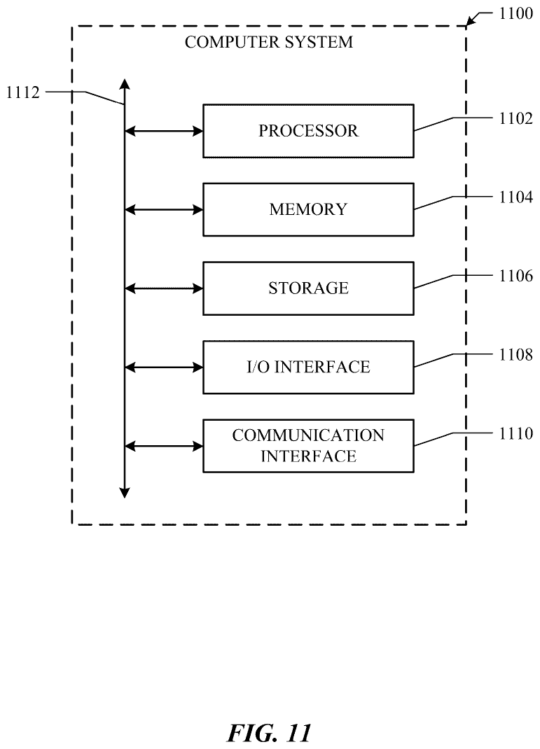

FIG. 11 illustrates an example computer system 1100. In particular embodiments, one or more computer systems 1100 perform one or more steps of one or more methods described or illustrated herein. In particular embodiments, one or more computer systems 1100 provide functionality described or illustrated herein. In particular embodiments, software running on one or more computer systems 1100 performs one or more steps of one or more methods described or illustrated herein or provides functionality described or illustrated herein. Particular embodiments include one or more portions of one or more computer systems 1100. Herein, reference to a computer system may encompass a computing device, and vice versa, where appropriate. Moreover, reference to a computer system may encompass one or more computer systems, where appropriate.

This disclosure contemplates any suitable number of computer systems 1100. This disclosure contemplates computer system 1100 taking any suitable physical form. As example and not by way of limitation, computer system 1100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1100 may include one or more computer systems 1100; be unitary or distributed; span multiple locations; span multiple machines; span multiple data centers; or reside in a cloud, which may include one or more cloud components in one or more networks. Where appropriate, one or more computer systems 1100 may perform without substantial spatial or temporal limitation one or more steps of one or more methods described or illustrated herein. As an example and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate.

In particular embodiments, computer system 1100 includes a processor 1102, memory 1104, storage 1106, an input/output (I/O) interface 1108, a communication interface 1110, and a bus 1112. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1102 includes hardware for executing instructions, such as those making up a computer program. As an example and not by way of limitation, to execute instructions, processor 1102 may retrieve (or fetch) the instructions from an internal register, an internal cache, memory 1104, or storage 1106; decode and execute them; and then write one or more results to an internal register, an internal cache, memory 1104, or storage 1106. In particular embodiments, processor 1102 may include one or more internal caches for data, instructions, or addresses. This disclosure contemplates processor 1102 including any suitable number of any suitable internal caches, where appropriate. As an example and not by way of limitation, processor 1102 may include one or more instruction caches, one or more data caches, and one or more translation lookaside buffers (TLBs). Instructions in the instruction caches may be copies of instructions in memory 1104 or storage 1106, and the instruction caches may speed up retrieval of those instructions by processor 1102. Data in the data caches may be copies of data in memory 1104 or storage 1106 for instructions executing at processor 1102 to operate on; the results of previous instructions executed at processor 1102 for access by subsequent instructions executing at processor 1102 or for writing to memory 1104 or storage 1106; or other suitable data. The data caches may speed up read or write operations by processor 1102. The TLBs may speed up virtual-address translation for processor 1102. In particular embodiments, processor 1102 may include one or more internal registers for data, instructions, or addresses. This disclosure contemplates processor 1102 including any suitable number of any suitable internal registers, where appropriate. Where appropriate, processor 1102 may include one or more arithmetic logic units (ALUs); be a multi-core processor; or include one or more processors 1102. Although this disclosure describes and illustrates a particular processor, this disclosure contemplates any suitable processor.

In particular embodiments, memory 1104 includes main memory for storing instructions for processor 1102 to execute or data for processor 1102 to operate on. As an example and not by way of limitation, computer system 1100 may load instructions from storage 1106 or another source (such as, for example, another computer system 1100) to memory 1104. Processor 1102 may then load the instructions from memory 1104 to an internal register or internal cache. To execute the instructions, processor 1102 may retrieve the instructions from the internal register or internal cache and decode them. During or after execution of the instructions, processor 1102 may write one or more results (which may be intermediate or final results) to the internal register or internal cache. Processor 1102 may then write one or more of those results to memory 1104. In particular embodiments, processor 1102 executes only instructions in one or more internal registers or internal caches or in memory 1104 (as opposed to storage 1106 or elsewhere) and operates only on data in one or more internal registers or internal caches or in memory 1104 (as opposed to storage 1106 or elsewhere). One or more memory buses (which may each include an address bus and a data bus) may couple processor 1102 to memory 1104. Bus 1112 may include one or more memory buses, as described below. In particular embodiments, one or more memory management units (MMUs) reside between processor 1102 and memory 1104 and facilitate accesses to memory 1104 requested by processor 1102. In particular embodiments, memory 1104 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1104 may include one or more memories 1104, where appropriate. Although this disclosure describes and illustrates particular memory, this disclosure contemplates any suitable memory.

In particular embodiments, storage 1106 includes mass storage for data or instructions. As an example and not by way of limitation, storage 1106 may include a hard disk drive (HDD), a floppy disk drive, flash memory, an optical disc, a magneto-optical disc, magnetic tape, or a Universal Serial Bus (USB) drive or a combination of two or more of these. Storage 1106 may include removable or non-removable (or fixed) media, where appropriate. Storage 1106 may be internal or external to computer system 1100, where appropriate. In particular embodiments, storage 1106 is non-volatile, solid-state memory. In particular embodiments, storage 1106 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1106 taking any suitable physical form. Storage 1106 may include one or more storage control units facilitating communication between processor 1102 and storage 1106, where appropriate. Where appropriate, storage 1106 may include one or more storages 1106. Although this disclosure describes and illustrates particular storage, this disclosure contemplates any suitable storage.

In particular embodiments, I/O interface 1108 includes hardware, software, or both, providing one or more interfaces for communication between computer system 1100 and one or more I/O devices. Computer system 1100 may include one or more of these I/O devices, where appropriate. One or more of these I/O devices may enable communication between a person and computer system 1100. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1108 for them. Where appropriate, I/O interface 1108 may include one or more device or software drivers enabling processor 1102 to drive one or more of these I/O devices. I/O interface 1108 may include one or more I/O interfaces 1108, where appropriate. Although this disclosure describes and illustrates a particular I/O interface, this disclosure contemplates any suitable I/O interface.

In particular embodiments, communication interface 1110 includes hardware, software, or both providing one or more interfaces for communication (such as, for example, packet-based communication) between computer system 1100 and one or more other computer systems 1100 or one or more networks. As an example and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1110 for it. As an example and not by way of limitation, computer system 1100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1100 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1100 may include any suitable communication interface 1110 for any of these networks, where appropriate. Communication interface 1110 may include one or more communication interfaces 1110, where appropriate. Although this disclosure describes and illustrates a particular communication interface, this disclosure contemplates any suitable communication interface.

In particular embodiments, bus 1112 includes hardware, software, or both coupling components of computer system 1100 to each other. As an example and not by way of limitation, bus 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1112 may include one or more buses 1112, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
accessing a sequence of raw images comprising at least a first raw image, a second raw image, and a third raw image sequentially, wherein the second raw image comprises image noise;
warping the first and third raw images with respect to the second raw image based on an optical flow associated with the sequence of raw images;
generating an input tensor based on the first warped raw image, the second raw image, and the third warped raw image; and
generating, based on one or more machine-learning models, a denoised raw image for the second raw image based on the input tensor.

2. The method of claim 1, wherein the sequence of raw images are associated with different viewpoints.

3. The method of claim 1, wherein the sequence of raw images are misaligned.

4. The method of claim 1, wherein each of the sequence of raw images is based on RGGB channels.

5. The method of claim 1, further comprising:
separating each of the first warped raw image, the second raw image, and the third warped raw image to a first number of channels, wherein generating the input tensor comprises combining the first warped raw image, the second raw image, and the third warped raw image based on the first number of channels associated with each of the first warped raw image, the second raw image, and the third warped raw image.

6. The method of claim 5, wherein the input tensor is associated with a second number of channels, and wherein the second number is greater than the first number.

7. The method of claim 5, further comprising:
generating, based on the input tensor by the one or more machine-learning models, an intermediate raw image, wherein the intermediate raw image is associated with the first number of channels; and
reassembling the first number of channels associated with the intermediate raw image to generate the denoise raw image.

8. The method of claim 1, further comprising generating the optical flow associated with the sequence of raw images, wherein the generation comprises:
converting the first raw image, the second raw image, and the third raw image to a first black-and-white raw image, a second black-and-white raw image, and a third black-and-white raw image, respectively;
generating an initial optical flow based on the first, second, and third black-and-white raw images, wherein the initial optical flow is associated with the second resolution; and
generating the optical flow by increasing a resolution of the initial optical flow from the second resolution to the first resolution.

9. The method of claim 8, wherein each of the first, second, and third raw images is associated with a first resolution, wherein each of the first, second, and third black-and-white raw images is associated with a second resolution, and wherein the second resolution is lower than the first resolution.

10. The method of claim 1, further comprising:
generating, based on one or more image signal processors, a denoised RGB or YUV image from the denoised raw image.

11. The method of claim 1, further comprising:
comparing the denoised RGB or YUV image with a ground-truth clean image; and
updating the one or more machine-learning models based on the comparison.

12. The method of claim 1, wherein generating the denoised raw image for the second raw image based on the input tensor comprises:
processing the input tensor based on the one or more machine-learning models to generate a luminance image and a chrominance image;
splitting the luminance image into a plurality of first tiles;
splitting the chrominance image into a plurality of second tiles;
processing the plurality of first tiles based on the one or more machine-learning models to generate a plurality of denoised first tiles;
processing the plurality of first tiles based on the one or more machine-learning models to generate a plurality of denoise second tiles; and
combining the plurality of denoise first tiles and the plurality of denoise second tiles to generate the denoised raw image for the second raw image.

13. The method of claim 12, wherein the luminance image is based on a plurality of luminance channels, wherein the chrominance image is based on a plurality of first luminance-chrominance channels, wherein the input tensor is based on a plurality of second luminance-chrominance channels, wherein a number of the plurality of luminance channels is smaller than a first number of the plurality of first luminance-chrominance channels, and wherein the first number of the plurality of the first luminance-chrominance channels is smaller than a second number of the plurality of second luminance-chrominance channels.

14. The method of claim 12, wherein the luminance image is based on a plurality of luminance channels, wherein the chrominance image is based on a plurality of chrominance channels, wherein the input tensor is based on a plurality of luminance-chrominance channels, and wherein a first number of the plurality of luminance channels and a second number of the plurality of chrominance channels are each smaller than a third number of the plurality of luminance-chrominance channels.

15. The method of claim 14, wherein each of the plurality of denoised first tiles is based on the plurality of luminance channels, and wherein each of the plurality of denoised second tiles is based on the plurality of chrominance channels.

16. The method of claim 12, wherein the one or more machine-learning models comprise a neural network comprising a luminance network and a chrominance network, wherein generating the plurality of denoised first tiles is based on the luminance network, and wherein generating the plurality of denoised second tiles is based on the chrominance network.

17. The method of claim 16, wherein a first size of the luminance network is larger than a second size of the chrominance network.

18. The method of claim 12, wherein each of the plurality of first tiles is based on a first padding overlap of a first number of pixels, wherein each of the plurality of second tiles is based on a second padding overlap of a second number of pixels, and wherein the first number is smaller than the second number.

19. One or more computer-readable non-transitory storage media embodying software that is operable when executed to:
access a sequence of raw images comprising at least a first raw image, a second raw image, and a third raw image sequentially, wherein the second raw image comprises image noise;
warp the first and third raw images with respect to the second raw image based on an optical flow associated with the sequence of raw images;
generate an input tensor based on the first warped raw image, the second raw image, and the third warped raw image; and
generate, based on one or more machine-learning models, a denoised raw image for the second raw image based on the input tensor.

20. A system comprising: one or more processors; and a non-transitory memory coupled to the processors comprising instructions executable by the processors, the processors operable when executing the instructions to:
access a sequence of raw images comprising at least a first raw image, a second raw image, and a third raw image sequentially, wherein the second raw image comprises image noise;
warp the first and third raw images with respect to the second raw image based on an optical flow associated with the sequence of raw images;
generate an input tensor based on the first warped raw image, the second raw image, and the third warped raw image; and
generate, based on one or more machine-learning models, a denoised raw image for the second raw image based on the input tensor.
